(19) United States
(12) Patent Application Publication
(10) Pub. No.: US 2018/0027771 A1
(43) Pub. Date: Feb. 1, 2018

(54) GENUINE-MATERIAL TEST PIECES FOR TRAINING EXPLOSIVES SNIFFER DOGS

(71) Applicant: DIEHL DEFENCE GMBH & CO. KG, UEBERLINGEN (DE)

(72) Inventors: THOMAS WACHTER, NUERNBERG (DE); SIEGFRIED WALDVOGEL, GAU-ALGESHEIM (DE); MALTE BRUTSCHY, MAINZ (DE); OLIVER PHAM-SCHOENWETTER, LAUF (DE); VANESSA MARTIN, ERLANGEN (DE)

(21) Appl. No.: 15/728,925

(22) Filed: Oct. 10, 2017

Related U.S. Application Data
(63) Continuation of application No. PCT/EP2016/000467, filed on Mar. 16, 2016.

(30) Foreign Application Priority Data
Apr. 10, 2015 (DE) 10 2015 004 712.4

(51) Int. Cl. A01K 15/02

(52) U.S. Cl. CPC A01K 15/02

(57) ABSTRACT

A genuine-material test piece for the training of explosives sniffer dogs includes an explosive assimilated by a solid or liquid carrier material, a housing having an interior space, and a closure for a reversible gastight closure of the interior space or a space including the interior space. The carrier material with the explosive is contained in the interior space. A gas-permeable device prevents the carrier material from escaping from the interior space if the interior space or the space including the interior space is not gas-tightly closed by the closure.

### CROSS-REFERENCE TO RELATED APPLICATION

This application is a continuation, under 35 U.S.C. §120, of copending international Application PCT/EP2016/000467, filed Mar. 16, 2016, which designated the United States; this application also claims the priority, under 35 U.S.C. §119, of German Patent Application DE 10 2015 004 712.4, filed Apr. 10, 2015; the prior applications are herewith incorporated by reference in their entirety.

### BACKGROUND OF THE INVENTION

### Field of the Invention

The invention relates to a genuine-material test piece for the training of explosives sniffer dogs, which includes an explosive assimilated by a carrier material in a housing.

It is known from German Publication DE 10 2009 029 787 A1, corresponding to U.S. Pat. Nos. 8,603,270 and 8,765,481, to use a solution of a neutral ionic liquid with a detectable amount of a peroxidic explosive as a source of odor for the training of explosives sniffer dogs. The peroxidic explosive can take the form of triacetone triperoxide (TATP) or hexamethylenetriperoxidediamine (HMTD), for example. By dissolving the explosives in the ionic solvent, a stable and easy-to-handle form of the respective explosive is obtained. The mechanical and thermal sensitivity of the explosive is significantly reduced by the solution in the ionic liquid, so that the solution is easy to handle in conventional laboratories with the customary equipment.

Furthermore, the use of a genuine-material micro-quantity test piece (EMPK®) from ExploTech GmbH, Cologne, Germany is known in the art for the training of sniffer dogs. That test piece takes the form of a metal foam containing small traces of explosive. However, the quantity of explosive contained therein is only sufficient for a relatively short discharge of an odorous substance trace, due to the volatility of the odorous substances contained therein. The metal foam containing the explosive can be contained in a carrier housing formed, for example, of brass. The release of the odorous substance trace of the test piece can be started by a puncture into a defined puncture site on the underside of the housing.

### SUMMARY OF THE INVENTION

It is accordingly an object of the invention to provide a genuine-material test piece suitable for the training of explosives sniffer dogs, which overcomes the hereinafore-mentioned disadvantages of the heretofore-known test pieces of this general type and which allows a relatively long and repeated use of the genuine-material test piece.

With the foregoing and other objects in view there is provided, in accordance with the invention, a genuine-material test piece for the training of explosives sniffer dogs. The genuine-material test piece includes an explosive assimilated by a solid or liquid carrier material in a housing with an interior space and a closure for the reversible gastight closure of the interior space, or a space including the interior space. In this case, the carrier material with the explosive is contained in the interior space. The genuine-material test piece furthermore includes a gas-permeable device for preventing the carrier material from escaping from the interior space if the interior space, or the space, is not closed by using the closure in a gastight manner.

As a result of the gastight closure by using the closure, odorous substances emitted from the explosive cannot pass from the interior space onto the outer face of the genuine-material test piece, and cannot be detected there by the explosives sniffer dog. The closure can take the form, for example, of a cover, a cap or a plug, in particular, one made from an elastic material.

Irrespective of the carrier material used, the concentration of the explosive in the carrier material is selected in such a way that, on one hand, the evaporating quantity of odorous substance is sufficient for detection by the explosives sniffer dogs and, on the other hand, the explosive is diluted to the extent that it can no longer be detonated. The explosive can then no longer be caused to explode by friction, impact or heating. As a result, the explosive used is no longer subject to the laws governing the handling of explosives. They can be handled and transported without risk, and without observation of the requirements and safety rules that are applicable to explosives. In order to avoid incorrect imprinting of the sniffer dogs, it is advantageous if all the components of the genuine-material test piece have no intrinsic odor, or at most a faint intrinsic odor, apart from that of the explosive. The carrier material, the housing, the closure and the device for preventing the carrier material from escaping, should therefore be odorless or at least faint-in-odor. As a result, it can be achieved that, after opening of the closure, the inventive genuine-material test piece only allows the escape of odorous substance molecules from the explosive, or at least substantially only odorous substance molecules from the explosive. In this way, any influence on the intrinsic odor of the explosive exerted by the other components of the genuine-material test piece is, at least to a large extent, also avoided.

“A gastight closure of the interior space” is understood to mean that by using the closure, odorous substances are prevented from being able to escape from the interior space into a region external to the genuine-material test piece. This can be achieved either by a direct closure of the interior space, or also by a gastight closure of a space including the interior space, so that while odorous substance molecules can leave the interior space, they cannot leave the closed genuine-material test piece.

Through the use of the reclosable gastight closure, the genuine-material test piece according to the invention enables odorous substance molecules emitted by the explosive to escape only when the closure is open. Since the odorous substances of the explosive assimilated in the carrier material can be relatively volatile, the total useful life of the genuine-material test piece can be considerably lengthened by this measure. Through the use of the reclosable closure for the purposes of gastight closure of the interior space, the latter can be closed in such a way that firstly no more volatile substances escape from the interior space of the housing, and that after reaching saturation of the air in the interior space with volatile substances from the explosive, no further volatile substances escape from the explosive until, by the reopening of the closure, the concentration of the volatile constituents of the explosive in the air surrounding the carrier material decreases once again in the interior space of the housing. This ensures repeated and safe use of the genuine-material test piece over a longer period of time.

The liquid carrier material can be an ionic liquid, such as that described, for example, in German Publication DE 10 2009 029 787 A1, corresponding to U.S. Pat. Nos. 8,603,270 and 8,765,481. In this case this can take the form, for example, of a lipophilic and/or neutral ionic liquid. Suitable lipophilic anions of the ionic liquid are, inter alia, tetrafluoroborates, triflimides, perfluoroalkylsulfates, alkylsulfonates, arylsulfonates, perfluoroalkylsulfonates, bis-perfluoroalkylsulfonim ides, acetates, alkylcarboxylates, isocyanates, isothiocyanates, thiosulfates, halides (including iodides, bromides, chlorides and fluorides), borates, phosphates, nitrates and perchlorates, wherein tetrafluoroborates and triflimides are particularly suitable. Suitable cations of the ionic liquid are N-alkyl-substituted nitrogen heterocycles, such as N-alkylpyridinium, N-alkylpyrazinium, N-alkylpyridazinium, N-alkylpyrimidinium and bis-N-alkylimidazolium ions, quaternary ammonium and phosphonium ions, wherein N,N-dialkylimidazolium and N-alkylpyridinium ions are particularly preferred. Particularly suitable ionic liquids are 1-ethyl-3-methylimidazoliumbis(trifluoromethanesulfonimide), 1-butyl-3-methylimidazoliumbis(trifluoromethanesulfonimide), 1-hexyl-3-methylimidazolium-bistrifluoromethanesulfonimide), 1-ethyl-3-methylimidazolium tetrafluoroborate, 1-hexy-3-methylimidazolium tetrafluoroborate, 1-octyl-3-methylimidazolium tetrafluoroborate, 1-decyl-3-methylimidazolium tetrafluoroborate, 1-decyl-3-methylimidazolium tetrafluoroborate, N-hexylpyridiniumtetrafluoroborate, N-hexylpyridiniumbis(trifluomethanesulfonimide), N-butyl-3-methylpyridinium tetrafluoroborate and N-butyl-4-methylpyridinium tetrafluoroborate. Ionic liquids have the advantage of an extremely low vapor pressure and thus do not influence an odor signature of the explosive, or at least not substantially.

A solid carrier material is particularly suitable for those explosives that are not soluble, or are not readily soluble, in an ionic liquid. A solid carrier material, in particular an odor-neutral, inert material, such as, for example, kieselguhr or diatomaceous earth, comes into consideration. Kieselguhr is a powder-form white solid, which is formed for the most part of silicon dioxide of shells of fossilized diatoms. Kieselguhr is chemically inert, has a high absorption capacity, is odorless and non-flammable. Kieselguhr is very light and highly porous. In order to be assimilated by the solid carrier material, the explosive is either applied as a solution, or as a solid, onto the inert material, and/or mixed with the latter. In this way, the explosive is diluted, thereby losing its ability to detonate and its sensitivity to impact, friction, and heat.

If the solid carrier material is in powdered form, for example in the form of kieselguhr, the device for preventing the carrier material from escaping from the interior space can be an odorless, or at least faint-in-odor, filter material, such as, for example, glass wool and/or glass filter paper, which is plugged into an opening of the interior space, and thereby prevents the powder-form solid carrier material from trickling out.

The housing and/or the closure of the genuine-material test piece can be composed, at least substantially, of glass or a metal. The metal can take the form of a stainless steel. These materials can be provided particularly easily in an odorless form, or at least in a faint-in-odor form.

The housing and/or the closure can include a seal. In this way, the gastight closure of the interior space by the closure can be particularly reliably ensured. An odorless, or at least a faint-in-odor, seal, is particularly suitable. For this purpose, the seal can be formed, for example, of polytetrafluoroethylene (PTFE).

The closure can be constructed as a screw closure. In this way, the gastight closure of the interior space can likewise be particularly reliably ensured. The gastight closure is very particularly reliable if the closure is constructed as a screw closure, and a seal is present that is compressed by the closure of the screw closure.

In one configuration of the genuine-material test piece according to the invention, the carrier material is liquid, and the device for preventing the escape of the carrier material is an absorbent material. The absorbent material, can take the form, for example, of glass wool, or another material that can absorb the liquid carrier material with the aid of capillary forces. Such a material can simply be plugged into the interior space in such a way that it cannot fall out. If the carrier material no longer releases any odorous substance traces of the explosive, such an absorbent material can be re-impregnated or further impregnated with virgin liquid carrier material containing the explosive, for example by using a pipette, without having to be removed from the interior space.

A leakage of explosive assimilated in liquid carrier material from the interior space, can, for example, also be prevented by the use of a particularly non-odorous or faint-in-odor, membrane that is permeable to gas, but impermeable to liquid, as the device for preventing the carrier material from escaping from the interior space. The membrane closes the interior space.

The device for preventing the carrier material from escaping can include at least one of the materials: glass wool, nonwoven glass fiber, glass filter paper and glass fiber filter. All of these materials can be provided in an odorless form, or at least in a faint-in-odor form.

In one configuration of the genuine-material test piece according to the invention, the housing includes a gas-permeable device for protecting the device for preventing the carrier material from escaping from mechanical damage, and/or for providing additional protection against a fall-out of the device for preventing the carrier material from escaping from the interior space when the closure is separated from the housing. Alternatively, such a device can also be disposed on the housing. The device for providing protection and/or additional protection can include a web or a grid formed of a metal, in particular stainless steel. The device for providing protection against mechanical damage is generally constructed as a physical barrier.

The protection is additional, because the device for preventing the carrier material from escaping itself already protects the device from falling out of the interior space if the interior space is not closed. In such a situation, however, it is not possible to completely rule out a fall-out as a result of mechanical action. The additional protection against falling out can reliably prevent contamination of the environment with the explosive. The explosive can be assimilated, for example, in a liquid carrier material, with which an absorbent material, for example a metal foam, is impregnated as a device for preventing escape. A protection against mechanical damage can, for example, prevent damage to the device for preventing the carrier material from escaping as a result of a dog bite, or in the event of a fall of the genuine-material test piece. If the device for providing protection and/or additional protection is constructed in the form of a grid, this has the advantage that a device in the form of an absorbent material disposed in the interior space for preventing the carrier material from escaping, can be impregnated through the grid by using a pipette with the explosive assimilated by a liquid carrier material, without having to be removed from the interior space.

The device for preventing the escape of the carrier material from the interior space and in the presence of the device for providing protection against mechanical damage and/or for providing additional protection against falling out, can be configured or disposed on the housing in such a way that the carrier material is removed from the interior space and replaced by a similar or other carrier material with further explosive assimilated therein, and the interior space, when required, can be opened, for example by removing, sliding open, or unfolding the device for providing protection and/or additional protection, and after replacing the carrier material with the similar or other carrier material, can be reclosed, for example, by reattaching, pushing closed, or folding closed the device for providing protection and/or additional protection. In this case, the further explosive can be identical with the explosive initially assimilated by the carrier material.

For the purposes of opening and reclosing the interior space the housing can also be constructed in such a way that it can be disassembled and reassembled. For this purpose, suitable constructs, for example by the provision of a screw closure for the interior space, and also suitable materials, are known in the art to the person skilled in the art. By virtue of the option of replacing the carrier material, the housing can be reused if the explosive assimilated by the carrier material no longer delivers an odorous signal.

Other features which are considered as characteristic for the invention are set forth in the appended claims.

Although the invention is illustrated and described herein as embodied in genuine-material test pieces for training explosives sniffer dogs, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a genuine-material test piece according to the invention, in a closed state;

FIG. 2 is a perspective view of the genuine-material test piece according to the invention in an open state;

FIG. 3 is a longitudinal-sectional perspective view through the genuine-material test piece according to the invention without the interior space filled with carrier material, and without a device for preventing the escape of the carrier material;

FIG. 4 is a perspective view of a housing;

FIG. 5 is a perspective view of a clamping ring;

FIG. 6 is a perspective view of a closure;

FIG. 7 is a longitudinal-sectional perspective view of an alternative configuration of the housing in an open state; and

FIG. 8 is an exploded perspective view of components of the genuine-material test piece according to the invention, without the carrier material and the device for preventing the escape of the carrier material.

### DETAILED DESCRIPTION OF THE INVENTION

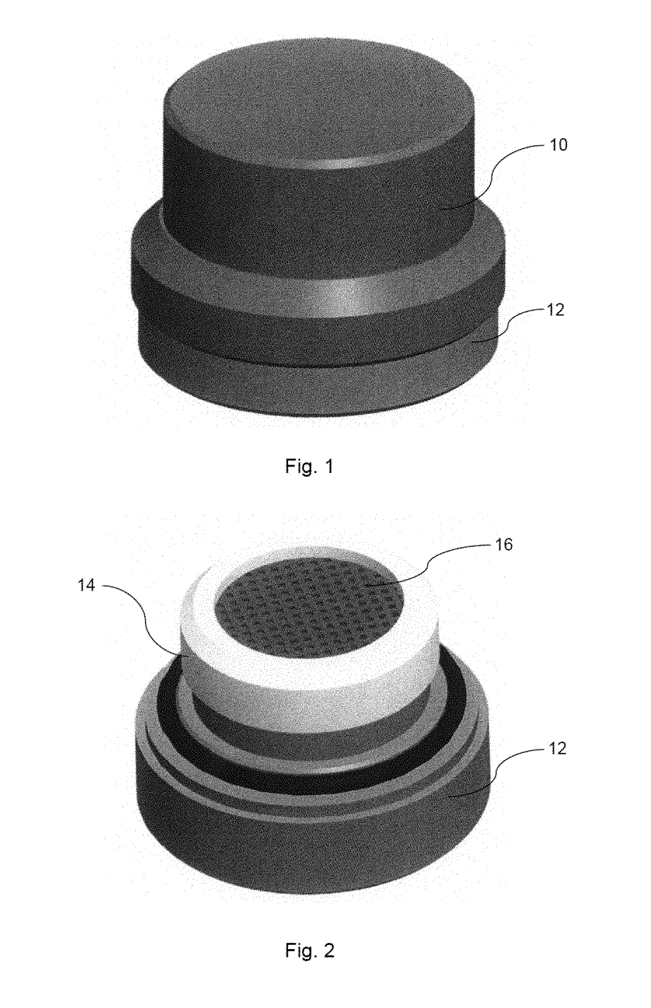

Referring now to the figures of the drawings in detail and first, particularly, to FIG. 1 thereof, there is seen a housing 12, which is closed by a closure 10 constructed as a cover. In this closed state, no odorous substances can penetrate outwards from an interior space 18 of the genuine-material test piece.

FIG. 2 shows the genuine-material test piece represented in FIG. 1 with the cover removed. The interior space 18, which cannot be seen therein, is closed by a grid 16 held by using a clamping ring 14. In this case, the grid 16 forms a gas-permeable protection device for providing protection against mechanical damage of the device for preventing the escape of the carrier material from the interior space 18.

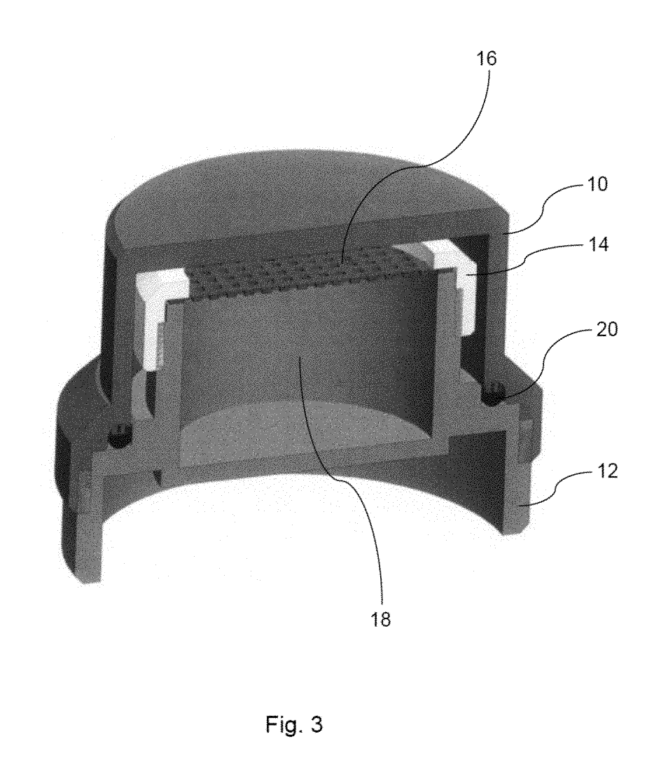

FIG. 3 is a diagrammatic, longitudinal-sectional view of the housing 12 that is closed in a gastight manner by the closure 10. In this case, an edge of the closure 10 presses against a circumferential seal 20 and thereby prevents the passage of odorous substances out of the interior space 18 through the grid 16 held by the clamping ring 14 to the outside. A space including the interior space 18 is closed in this way in a gastight manner, in accordance with the object of the invention. The carrier material with the explosive assimilated by the latter is not represented in FIG. 3.

As an alternative to sealing by way of the seal 20, sealing can also be achieved in that the closure 10, when closed, presses onto the elastically configured clamping ring 14, so that the interior space 18 is closed in this way in a gastight manner.

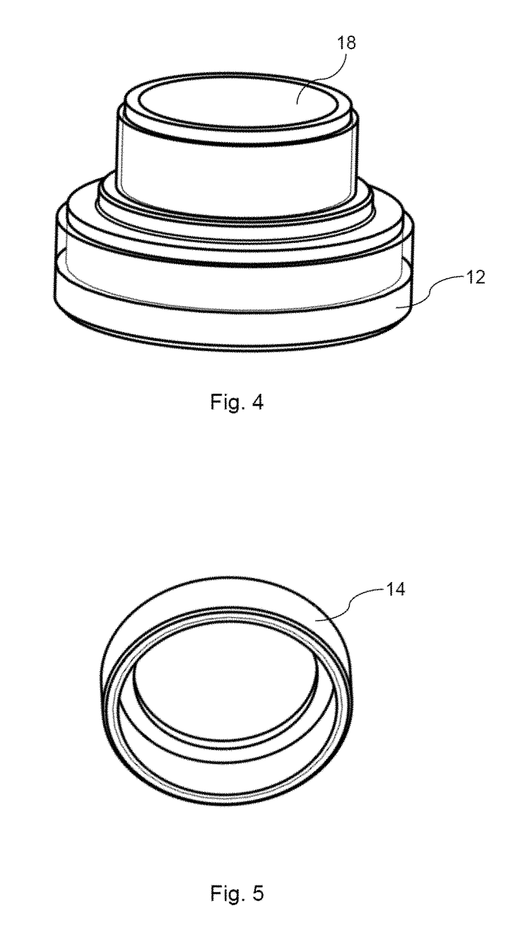

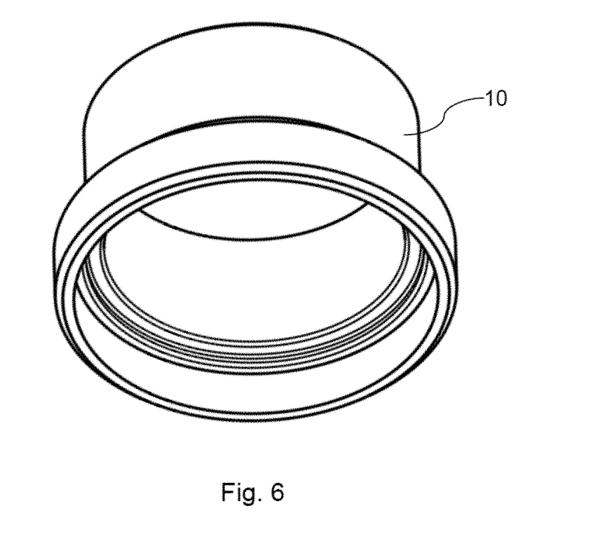

FIG. 4 shows the housing 12 with the interior space 18, FIG. 5 shows the clamping ring 14 and FIG. 6 shows the closure constructed as a cover 10, in each case in a separate representation.

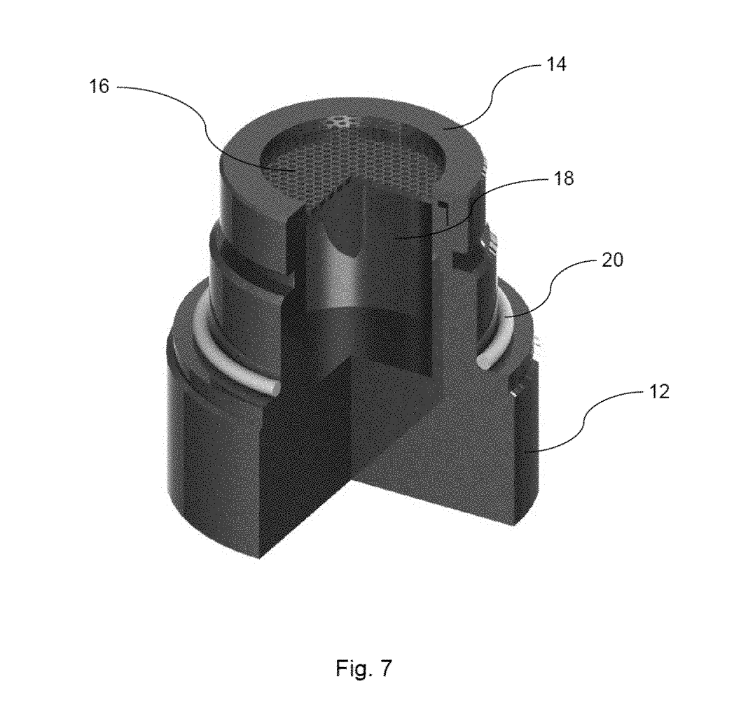

FIG. 7 shows an alternative representation of the genuine-material test piece according to the invention, in which the base of the housing 12 is constructed to be thicker than in the case of the genuine-material test piece represented in FIGS. 1 to 3. In this way, handling of the genuine-material test piece is made easier, because the base of the housing 12 can thereby be gripped more easily even under difficult conditions, for example when wearing work gloves. The rest of the structure corresponds to that shown in FIG. 3, that is to say, an interior space 18 is disposed in the housing 12. A non-illustrated device contained in the housing for preventing the carrier material from escaping is protected against mechanical damage by a grid 16 held by a clamping ring 14. A seal 20 enables a gastight closure when the closure 10 is in position.

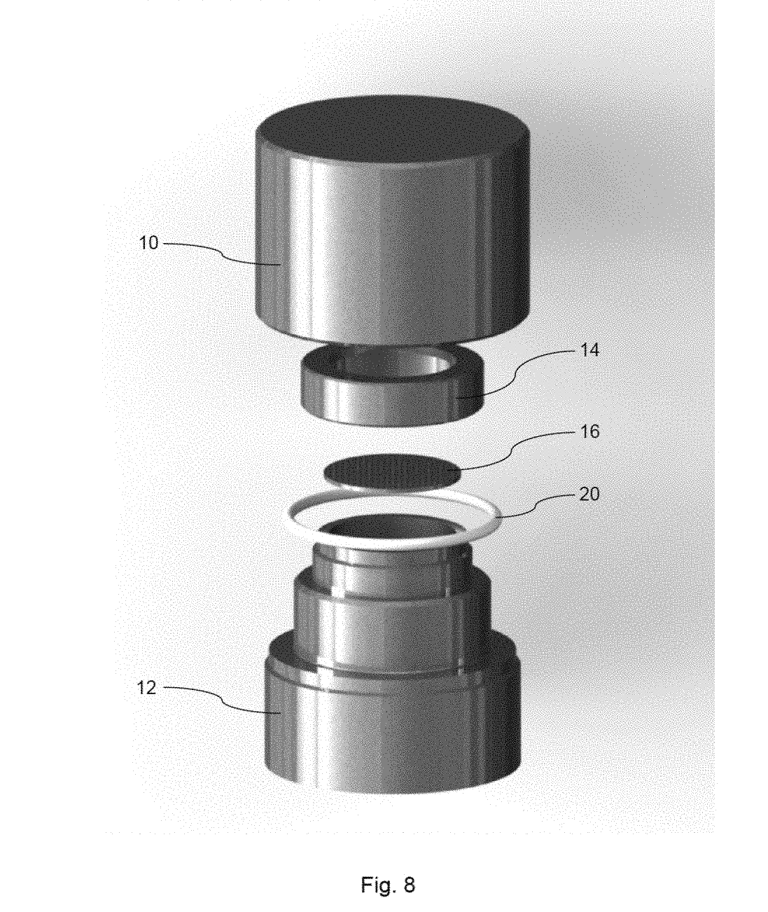

FIG. 8 is a diagrammatic, exploded perspective view of the genuine-material test piece according to the invention with a closure 10 for positioning onto the housing 12, wherein the gastight closure between the closure 10 and the housing 12 is ensured by the seal 20. The grid 16 can be inserted into the housing 12 and held by the clamping ring 14 in such a way that the interior space 18, not shown therein, or the device contained therein for preventing the carrier material from escaping from the interior space 18, is protected against mechanical damage.

1. A genuine-material test piece for the training of explosives sniffer dogs, the genuine-material test piece comprising:
a solid or liquid carrier material and an explosive assimilated by said carrier material;
a housing having an interior space or a space including said interior space for receiving said solid or liquid carrier material and said explosive;
a closure for a reversible gastight closure of said interior space or said space including said interior space;
a gas-permeable device for preventing said carrier material from escaping from said interior space if said interior space or said space including said interior space is not gas-tightly closed by said closure.

2. The genuine-material test piece according to claim 1, wherein said liquid carrier material is an ionic liquid and said solid carrier material is kieselguhr or diatomaceous earth.

3. The genuine-material test piece according to claim 1, wherein at least one of said housing or said closure is formed at least mostly of glass or a metal.

4. The genuine-material test piece according to claim 1, wherein at least one of said housing or said closure includes a seal.

5. The genuine-material test piece according to claim 1, wherein said closure is a screw closure.

6. The genuine-material test piece according to claim 1, wherein said carrier material is a liquid, and said gas-permeable device is an absorbent material.

7. The genuine-material test piece according to claim 1, wherein said gas-permeable device for preventing said carrier material from escaping includes at least one of glass wool, nonwoven glass fiber, glass filter paper or glass fiber filter.

8. The genuine-material test piece according to claim 1, which further comprises a gas-permeable protection device being part of said housing or disposed on said housing for at least one of:
preventing mechanical damage to said gas-permeable device for preventing said carrier material from escaping or
providing additional protection against a fall-out from said interior space of said gas-permeable device for preventing said carrier material from escaping, when said closure is separated from said housing.

9. The genuine-material test piece according to claim 8, wherein said gas-permeable protection device includes a web or a grid formed of a metal.

10. The genuine-material test piece according to claim 8, wherein:
said gas-permeable device for preventing said carrier material from escaping, being protected by said gas-permeable protection device, is configured or disposed on said housing for permitting said carrier material to be removed from said interior space and replaced by a similar or other carrier material with further explosive assimilated therein; and
said interior space can be opened when required and can be reclosed after replacing said carrier material with said similar or other carrier material.
